(19) United States
(12) Patent Application Publication
(10) Pub. No.: US 2017/0113657 A1
(43) Pub. Date: Apr. 27, 2017

(54) CONNECTION DEVICE FOR A WINDSCREEN WIPER BLADE

(71) Applicant: Valeo Systèmes d'Essuyage, Le Mesnil Saint Denis (FR)

(72) Inventors: Patrick Moneyron, Le Cendre (FR); Marie-Therese Hanino, Parent (FR); Philippe Espinasse, Coudes (FR); Guillaume Mouleyre, Saint Genes Champanelle (FR); William Terrasse, Vic-Le-Comte (FR)

(73) Assignee: Valeo Systèmes d'Essuyage, Le Mesnil Saint Denis (FR)

(21) Appl. No.: 15/296,272

(22) Filed: Oct. 18, 2016

(30) Foreign Application Priority Data
Oct. 22, 2015 (FR) 1560055
Oct. 22, 2015 (FR) 1560056

(51) Int. Cl. B60S 1/38; B60S 1/40

(52) U.S. Cl. CPC B60S 1/3856; B60S 1/40; B60S 1/381

(57) ABSTRACT

The invention relates to a connection device B for mechanically linking a wiper blade A to a windscreen wiper drive arm C, C′ of a motor vehicle, said connection device (B) includes a connector 2 designed to be rigidly attached to the wiper blade A and an adaptor 3 designed to connect the connector 2 to an end part 5, 5′ of the drive arm C, C′, in which the connector 2 includes at least one hole 24 of circular section through which the axis of rotation Y between the wiper blade A and the drive arm C, C′ passes, the hole 24 in the connector being delimited by at least one flank 23 of the connector 2 and the adaptor 3 having at least one through-seat 40, 40′ into which at least a portion of the flank 23 extends.

The present invention relates to the domain of windscreen wiper devices for motor vehicles and concerns more specifically the connection devices intended to mechanically link a wiper blade to a drive arm of such a windscreen wiper device.

Windscreen wipers for motor vehicles are designed to sweep away liquid and dirt that may obstruct the driver's view of the surrounding environment. These windscreen wipers usually comprise a drive arm performing an angular to-and-fro movement, and elongated wiper blades fitted with rubbers made of an elastic material. By rubbing against a glazed surface, these rubbers sweep away the water and some of the dirt from the driver's field of vision.

Regardless of the layout of the windscreen wiper blade, same is attached to the drive arm by a connection assembly that usually comprises at least one connector and one adaptor. The connector is rigidly connected to the wiper blade and the adaptor is a part that is designed firstly to cooperate with the connector and secondly to engage with and end part of the drive arm. The connector and the adaptor cooperate to attach the wiper blade to the drive arm and to form an articulated joint between these two assemblies.

In the after sales market for windscreen wiper blades, it is known to sell a single wiper blade, fitted with an appropriate connector, for several types of windscreen wiper arms. It is therefore useful to design an adaptor that can be used with as many different types of arms and connections as possible, since it is the adaptor that forms the interface between the connector pre-fitted to the wiper blade and each type of end part of the drive arm. In addition to an adaptor that can be used on the widest possible variety of arms and connection types, there is also a need for adaptors that can be used regardless of the driving side of the vehicle, i.e. regardless of whether the vehicle is driven on the left-hand side or the right-hand side of the carriageway. Indeed, the driving side of the vehicle on the carriageway determines the side (right or left) on which the steering wheel of the vehicle is installed, and therefore the preferred direction that the windscreen, for example, is wiped by a windscreen wiper blade.

These varieties of arms and end parts include in particular those referred to as “side lock”. In principle, an end part of this type includes a shaft and a substantially L-shaped pin. In this case, the shaft acts as the axis of rotation between the arm and the windscreen wiper blade, and the pin secures the mechanical link between the arm and the wiper blade, preventing any movement along the axis of the shaft. There are currently two sizes of side-lock connections, depending on the dimensions of the pin: one referred to as “standard side lock” and the other referred to as “narrow side lock”.

The present invention is intended to provide a reliable and robust mechanical connection between the connector and adaptor respectively of a wiper blade and a windscreen wiper arm that can be applied to a wide variety of end parts of windscreen wiper arms, including the end parts corresponding to side-lock connections, regardless of the size and connection direction of same, and that can also be applied to different assembly directions of the wiper blade and of the windscreen wiper arm depending on the side of the vehicle on which the steering is positioned.

For this purpose, the invention proposes a connection device for mechanically linking a wiper blade to a windscreen wiper drive arm of a motor vehicle that includes a connector designed to be rigidly attached to a wiper blade and an adaptor designed to connect the connector to an end part of the drive arm, in which the connector includes at least one hole through which the axis of rotation between the wiper blade and the drive arm passes, the hole in the connector being delimited by at least one flank of the connector, and the adaptor having at least one through-seat into which at least a portion of the flank extends. According to the invention, when the connector and the adaptor are assembled, the through-seat receives an upper portion of the connector.

According to another aspect, the invention proposes a connection device for mechanically linking a wiper blade to a windscreen wiper drive arm of a motor vehicle that includes a connector designed to be rigidly attached to a wiper blade and an adaptor designed to connect the connector to the drive arm. In the device according to the invention, the connector includes at least one hole that is able to receive a shaft of the drive arm, and the adaptor has at least one rotary bearing designed to receive the shaft of the drive arm, as well as means enabling attachment of this adaptor to the connector. In the device according to the invention, the adaptor also includes at least one cavity that is substantially perpendicular to an axis passing through the rotary bearing and that is designed to receive a pin of the drive arm. Furthermore, according to the invention, the rotary bearing, the hole designed to receive the shaft of the drive arm and the means for attaching the adaptor to the connector arc coaxial.

The connection device advantageously has the following features taken individually or in combination:
the through-seat is formed in an upper face delimiting the adaptor,
the through-seat is delimited by a closed edge,
the through-seat is centred on the adaptor, along a longitudinal axis of said adaptor, and borders two substantially flat portions of the upper face and two substantially convex portions delimiting the upper face of the adaptor,
the through-seat has, in projection on a plane parallel to the substantially flat first and second portions of the upper face, a substantially rectangular section in which the large side is parallel to the longitudinal axis of the adaptor and the small side is substantially parallel to the axis of rotation,
the through-seat is formed in a first convex portion and a second convex portion that form the upper face of the adaptor,
the adaptor is delimited by a first lateral flank and a second lateral flank, at least one of said lateral flanks having a shoulder formed on an edge opposite the edge via which the lateral flank is attached to the upper face of the adaptor,
each of the first and second lateral flanks of the adaptor has a shoulder that in particular delimits a notch designed to receive a pin of the drive arm,
at least one longitudinal slot is formed in the upper face of the adaptor,
at least one longitudinal slot is formed in at least one of the substantially flat first or second portions of the upper face of the adaptor,
at least one longitudinal slot is formed in the convex second portion of the upper face of the adaptor,
four slots, advantageously through-slots, are formed in the upper face of the adaptor, distributed symmetrically both about a longitudinal mid-plane perpendicular to the substantially flat portions of the upper face and about a transverse mid-plane perpendicular to the first and second lateral flanks of the adaptor,
the adaptor has a first end flank and a second end flank that extend transversely and substantially perpendicular to the first and second lateral flanks, and, on the side of same opposite the side by which same is attached to the upper face of the adaptor, at least one of the end flanks has a notch, which is substantially rectangular and that extends towards the upper face,
the adaptor is delimited by at least a first lateral flank and by a second lateral flank, a rotary bearing being provided in said first and second lateral flanks to receive a shaft of the drive arm,
the rotary bearing is formed by at least one orifice of circular section passing through the first and second lateral flanks, and the through-orifices are coaxial and of the same diameter, the centres of same being aligned on the axis of rotation,
the centres of the through-orifices are positioned substantially in the middle of the adaptor, in the longitudinal direction of same,
the centres of the through-orifices are aligned with the transverse axis of the concave first portion of the upper face of the adaptor,
a first cylindrical trunnion and a second cylindrical trunnion extend, coaxial with the through-orifices, inside a cavity formed by the first and second Intend flanks, the first and second end flanks, and the upper face of the adaptor,
the first and second cylindrical trunnions have the same internal diameter as the first and second through-orifices, which are arranged to face one another, and extend substantially towards one another within the volume of said cavity,
each of the cylindrical trunnions extends, inside the cavity, between the inner wall of one of the first or second lateral flanks and a reinforcing rib arranged parallel to said first or second lateral flank and extending, along the entire length of the adaptor, between the inner edges of each of the notches arranged respectively in the first and in the second end flank,
each of the first and second cylindrical trunnions opens out, at one end, into the inner wall of the corresponding lateral flank and opens out, at the other end, near to the corresponding reinforcing rib, passing through this latter and forming a cylindrical bead on the surface of said reinforcing rib, the axis of said bead being the same as the axis of rotation,
the profile of the upper face of the adaptor, near to each of the through-orifices, is identical to the profile of an upper wall of the flank of the connector near to the hole,
the mechanical link between the connector and the adaptor is made by engaging the cylindrical beads in the hole,
the cavity is delimited by a closed edge, and advantageously has a substantially rectangular section,
the adaptor has an overall substantially parallelepiped shape that is elongated in a direction parallel to the direction of the longitudinal axis of the wiper blade, and it has a first lateral flank and a second lateral flank that are arranged symmetrically about said longitudinal axis,
at least one of the first or second lateral flanks of the adaptor has a shoulder defining a gap on the lateral flank in question that is able to receive, for example bearingly, an end of a pin of an end part of an arm in a first variant of a standard side-lock connection. According to a preferred embodiment of the invention, such a gap is formed on each of the lateral flanks of the adaptor thereby making it possible to use the same connection device according to the invention for a wiper blade mounted on a driver-side or a passenger-side drive arm, using an identical or opposite “butterfly” angular movement,
the closed edge of the cavity is formed in a portion of an upper face of the adaptor,
the adaptor is delimited by lateral faces, and it includes at least one gap formed in one of said lateral faces, the gap being designed to receive a pin of a drive arm,
the adaptor includes at least one gap on each of the lateral faces of same,
the rotary bearing has a first bearing and a second bearing that are coaxial, the first bearing being separated from the second bearing by a recess that opens onto the upper face of the adaptor,
at least one portion of the connector projects into the recess in the adaptor between the first bearing and the second rotary bearing,
the adaptor delimits at least two internal volumes, each of the internal volumes being a longitudinal extension, along the longitudinal axis of the adaptor, of each rotary bearing formed in said adaptor,
the two internal volumes are formed on the same side of the adaptor between firstly the transverse axis common to the rotary bearing, the transverse hole and the attachment means, and secondly an end flank,
the adaptor has four internal volumes arranged in pairs on each side of the transverse axis and of the longitudinal axis of the adaptor,
the means for attaching the adaptor to the connector are cylindrical trunnions coming from the adaptor and seated in at least one matching hole formed in the connector,
the means for attaching the adaptor to the connector are formed by cylindrical trunnions that extend from the adaptor towards the connector coaxially with the rotary hearings,
the adaptor has, on at least one of the end flanks of same, a notch that advantageously has a rectangular profile,
the upper face of the adaptor, near to the rotary bearing, has a profile similar to the profile of an upper wall of the connector near to the central portion of this latter, in which the transverse hole is formed.

The invention also relates to a wiper blade for a vehicle characterized in that it includes a connection device as described above. Such a wiper blade may include a supporting element and a rubber, in which the supporting element takes the form of at least one curved metal blade, and in which the connection device is rigidly connected to the wiper blade substantially at the central portion of same.

The invention also relates to a wiper system for a vehicle, including at least one wiper blade, as mentioned in the paragraph above, attached to a drive arm by a connection device as described above, a shaft carried by an end part of the drive arm being seated in the rotary bearing of the adaptor, a pin being seated in the cavity. A single connection device cooperates with another drive arm that has a shaft carried by an end part of the drive arm seated in the rotary bearing of the adaptor, a pin being seated in a gap formed in a lateral flank of the adaptor.

Other features, details and advantages of the invention are set out more clearly in the description given below by way of example and in relation to the following drawings:

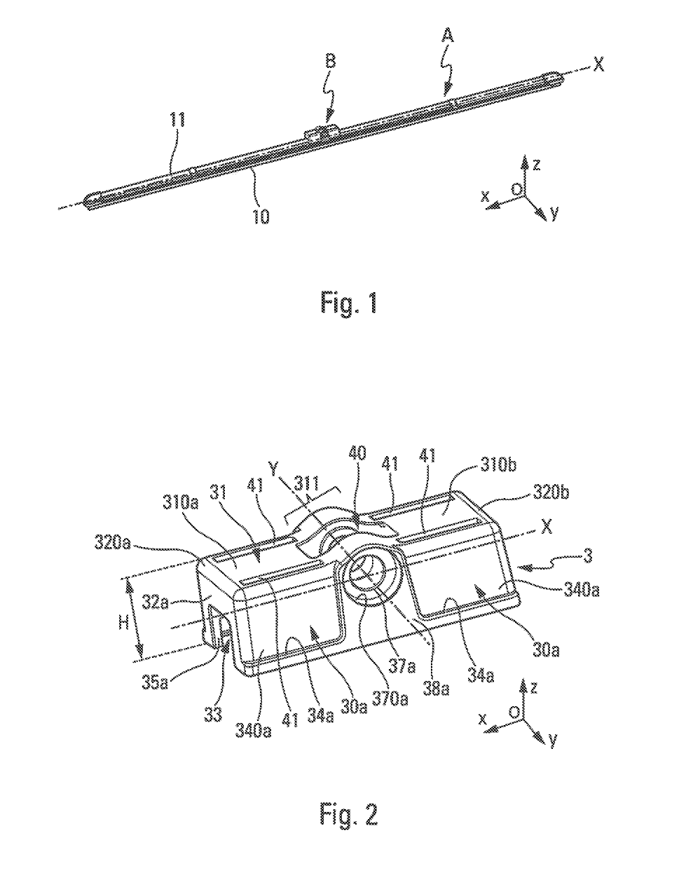

FIG. 1 is a perspective overview of a wiper blade fitted with a connection device according to the invention,

FIG. 2 is a perspective view of an adaptor of a connection device according to a first embodiment of the invention,

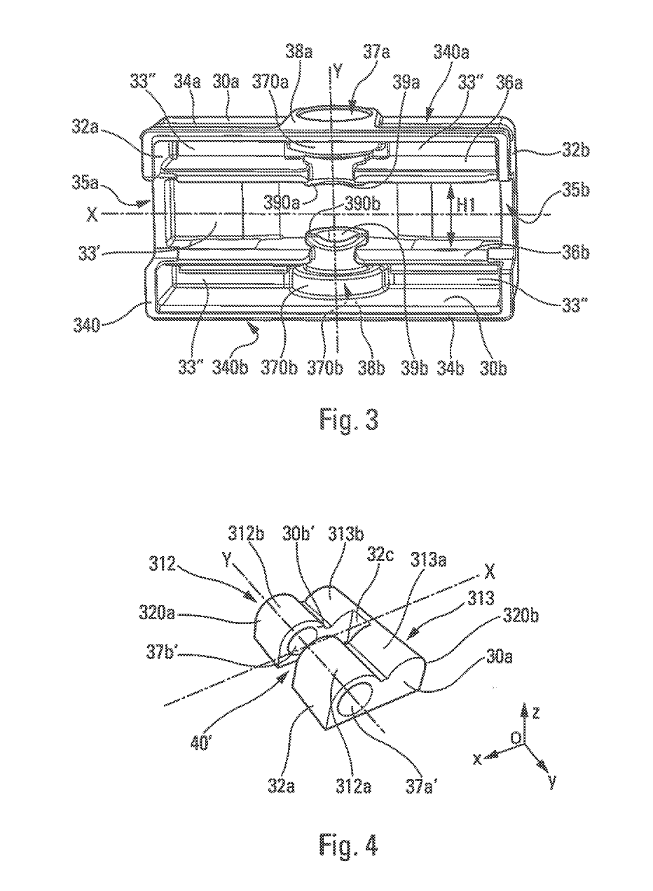

FIG. 3 is a bottom view of an adaptor of a device according to the invention, according to the first embodiment shown in FIG. 2,

FIG. 4 is a simplified perspective view of an adaptor of a connection device according to a second embodiment of the invention,

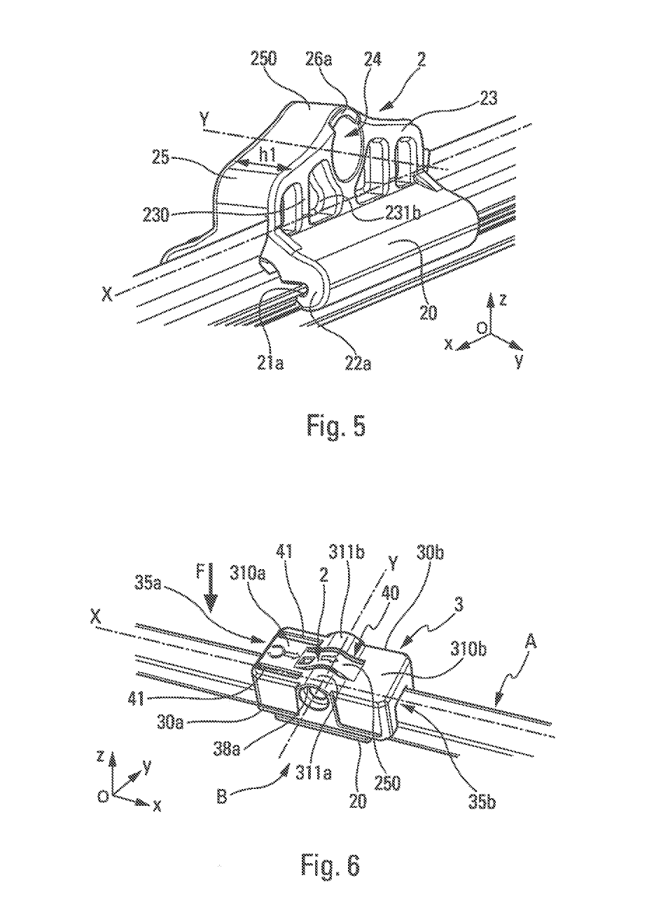

FIG. 5 is a perspective view of a connector of a connection device according to the invention,

FIG. 6 is a perspective view of a connection device according to the invention in which the connector and the adaptor according to the first embodiment, as shown in FIGS. 2 and 3, are assembled on a wiper blade,

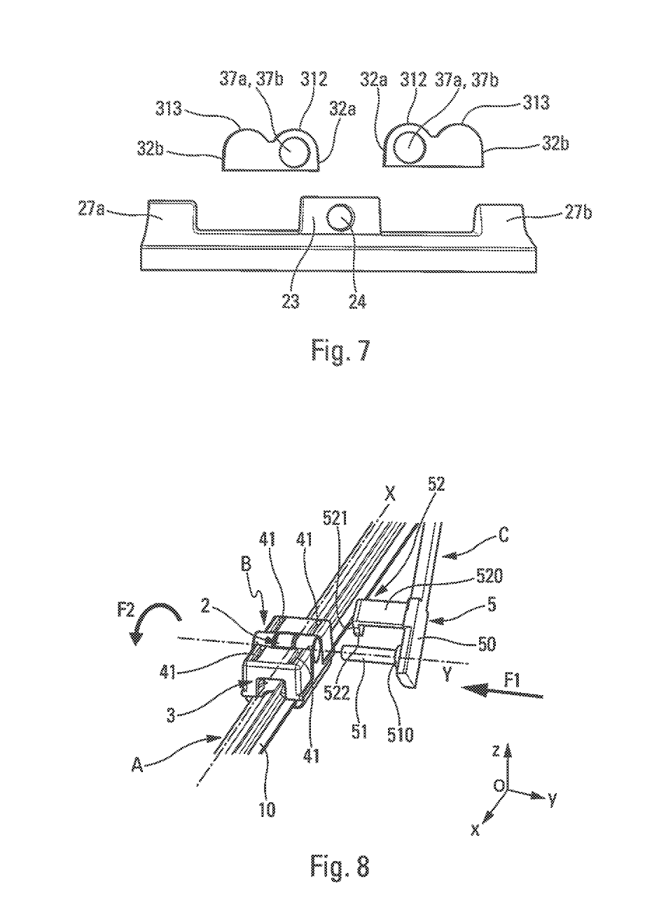

FIG. 7 is a front view showing the different linking options between the connector and the adaptor according to the second embodiment shown in FIG. 4,

FIG. 8 is a perspective view of assembly of the connection device according to the invention, in which the adaptor is as shown in the first embodiment shown in FIGS. 2 and 3, with an end part of a windscreen wiper arm in a narrow side-lock connection,

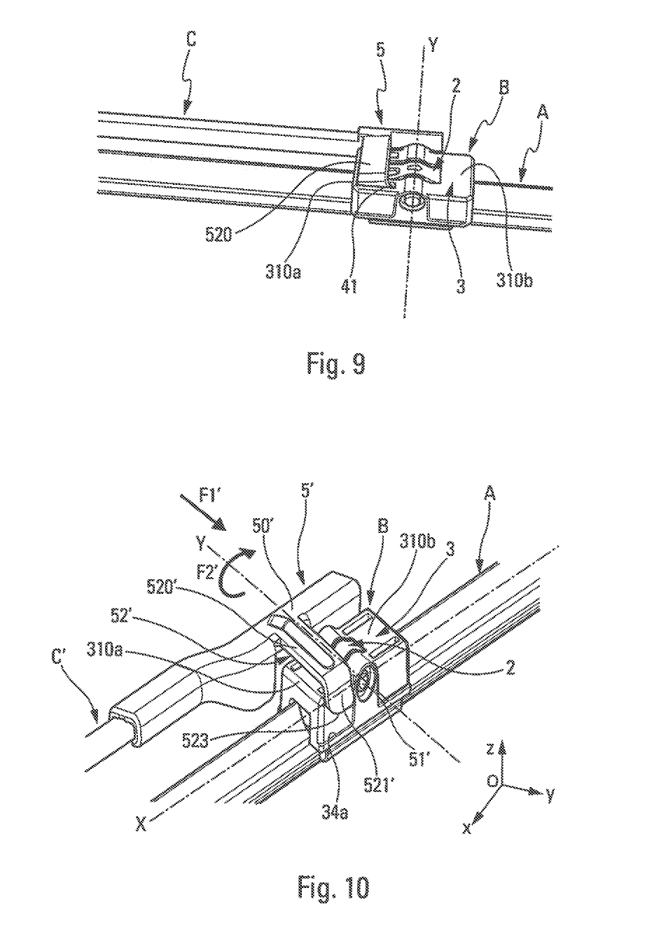

FIG. 9 is a perspective view of the assembly shown in FIG. 8, in assembled state,

FIG. 10 is a perspective view of assembly of the connection device according to the invention, in which the adaptor is as shown in the first embodiment shown in FIGS. 2 and 3, with an end part of a windscreen wiper arm in a standard side-lock connection.

It should first be noted that the figures show the invention in detail to enable the invention to be carried out, and these figures may naturally be used to better define the invention where appropriate.

In the remainder of the description, the terms longitudinal or lateral, above, below, front and rear shall refer to the orientation of the wiper blade or of the connection device according to the invention. The longitudinal direction, shown by the axis X in FIG. 1, corresponds to the direction of the main axis of the wiper blade A along which same extends. The lateral orientations are concurrent lines, i.e. lines that cross the longitudinal direction, in particular perpendicular to the longitudinal axis X of the wiper blade A to define the plane of movement of the drive arm performing an angular to-and-fro movement. The directions referenced as vertical, upper or lower are directions perpendicular to the plane in which the drive arm performs the angular two-and-fro movement, and the term lower encompasses the plane of the surface to be wiped.

The directions mentioned above are also visible in an orthonormal frame (Oxyz) shown in the figures. In this frame, the direction (Ox) is the direction of the longitudinal axis X in which the wiper blade extends lengthways, the direction (Oy) is the transverse direction that is perpendicular to the direction (Ox) and which, in combination with the direction (Ox), defines the plane in which the drive arm of the windscreen wiper performs the angular to-and-fro movement, and the direction (Ox) is the vertical direction perpendicular to the directions (Ox) and (Oy).

The wiper blade A shown in FIG. 1 includes, extending along the longitudinal axis X of same, a wiper blade 10, for example made of an elastomer, and a stiffening assembly for same forming a supporting element of the wiper blade A. This supporting element may, by way of nonlimiting example, comprise a metal strip enabling the blade to be applied to the surface to be wiped, while stiffening said blade. According to the embodiment shown in FIG. 1, an upper aerodynamic deflector in 11 is combined with the stiffening assembly in order to better press the blade A against the surface to be wiped, thereby improving the quality of the wiping provided by the wiper blade A. The wiper blade A is fitted with a connection assembly B according to the invention substantially at the centre of the longitudinal axis X of same. The connection assembly B includes a connector 2, shown in perspective in FIG. 5, and an adaptor 3, shown in FIGS. 2 and 3.

With reference to the different figures, the adaptor 3 according to the invention has a substantially parallelepipedic overall shape, notably elongated in a direction parallel to the direction of the longitudinal axis X of the wiper blade A. Advantageously, the adaptor 3 is made of synthetic material and is, for example, manufactured by injecting a polymer into an appropriate mould.

The adaptor 3 includes a first lateral flank 30a and a second lateral flank 30b that are arranged symmetrically about a midplane containing the longitudinal axis X and the vertical direction Oz, and that extend substantially parallel to said plane. In other words, each of the first and second lateral flanks 30a, 30b is substantially parallel to the plane (Oxz) of the orthonormal frame defined above.

The first and second lateral flanks 30a and 30b are in particular joined via an upper face of the adaptor 3.

The first and second lateral flanks 30a and 30b are notably joined via an upper face 31 to form a substantially inverted-U-shaped profile.

The upper face 31 has, for example and as illustrated in FIGS. 2 and 3, a first portion and a second portion, indicated using reference signs 310a and 310b respectively, that are substantially flat and perpendicular to the general plane in which the first and second lateral flanks 30a and 30b lie. The substantially flat first and second portions 310a, 310b of the upper face 31 are therefore substantially parallel to the plane (Oxy) of the orthonormal frame defined above. The first and second flat portions 310a, 310b are arranged symmetrically about a convex central portion 311 the shape of which matches a portion of the envelope of a cylinder centred on the transverse axis Y perpendicular to the longitudinal axis X and parallel to the general plane in which the flat portions of the upper face substantially lie, i.e. parallel to the direction of the axis (Oy) of the orthonormal frame defined above.

The adaptor 3 includes a first lateral flank 30a and a second lateral flank 30b that are arranged symmetrically about a mid-plane containing the longitudinal axis X and the vertical direction Oz, and that extend substantially parallel to said plane. In other words, each of the first and second lateral flanks 30a, 30b is substantially parallel to the plane (Oxz) of the orthonormal frame defined above.

According to the first embodiment shown in FIGS. 2 and 3, the first and second flat portions 310a, 310b of the upper face 31 are arranged symmetrically, in the longitudinal direction, about a convex central portion 311 the shape of which matches a portion of the envelope of a cylinder centred on a transverse axis perpendicular to the longitudinal axis X and parallel to the general plane in which the flat portions of the upper face substantially lie, i.e. parallel to the direction of the axis (Oy) of the orthonormal frame defined above.

The convex central portion 311 of the upper face 31 therefore extends, in the upper and lower directions defined above, above the flat portions 310a, 310b of said upper face 31. The first and second lateral flanks 30a and 30b of the upper face 31 have an elongated shape in the longitudinal direction of the axis X and end with the U-shaped section mentioned above. The central portion is deemed to be convex when observed from above the adaptor 3.

According to an example embodiment, at least one longitudinal slot 41 is formed in the upper face 31 of the adaptor 3.

According to the invention, at least one lengthways cavity 41, i.e. perpendicular to the transverse axis Y, may be formed through at least one of the substantially flat first or second portions 310a, 310b of the upper face 31 of the adaptor 3. According to the preferred embodiment shown in the figures, four cavities 41 are therefore formed through the upper face 31, distributed symmetrically in pairs both about a longitudinal mid-plane perpendicular to the substantially flat portions 310a, 310b of said upper face 31 and about a transverse mid-plane perpendicular to the first and second lateral flanks 30a, 30b of the adaptor 3. Two cavities 41 are therefore formed in each of these substantially flat portions 310a, 310b of the upper face 31. Each cavity 41 is perforated through the entire thickness of the substantially flat portions 310a, 310b of the upper face 31, making same a through-cavity. Furthermore, each cavity 41 is delimited by a closed edge. According to the embodiment shown in the figures, each cavity 41 has a substantially rectangular section in a plane substantially parallel to the plane of the substantially flat first and second portions 310a, 310b of the upper face 31 of the adaptor 3.

According to the first embodiment of the invention shown in FIGS. 2 and 3, the longitudinal slot 41 is formed in or through at least one of the substantially flat first or second portions 310a, 310b of the upper face 31 of the adaptor 3. According to the variant shown in particular in FIGS. 2 and 3, four cavities 41 are formed in the upper face 31, distributed symmetrically both about a longitudinal mid-plane perpendicular to the substantially flat portions 310a, 310b of said upper face 31 and about a transverse mid-plane perpendicular to the first and second lateral flanks 30a, 30b of the adaptor 3. Two slots 41 are therefore perforated in each of these substantially flat portions 310a, 310b of the upper face 31. Each slot 41 is formed through the entire thickness of the substantially flat portions 310a, 310b of the upper face 31, making same a through-slot. Furthermore, each slot 41 is delimited by a closed edge. According to the embodiment shown in FIGS. 2, 3, 6 and 8 to 10, each slot 41 has a substantially rectangular section in a plane substantially parallel to the plane of the flat first and second portions 310a, 310b of the upper face 31 of the adaptor 3.

According to the invention, a through-seat 40 is for example formed in the adaptor 3.

According to the first embodiment of the invention shown in FIGS. 2 and 3, this through-seat 40 is arranged in the upper face 31 of the adaptor 3, advantageously in the convex portion 311 of this upper face 31. According to this first embodiment of the invention, the through-seat 40, in projection on a plane substantially parallel to the flat first and second portions 310a, 310b of the upper face 31, is delimited by a closed edge and has a substantially rectangular section, the large side of which is parallel to the longitudinal axis X of the adaptor 3 and the small side of which is parallel to the axis of rotation Y. The axis of rotation Y is a transverse axis that is advantageously perpendicular to the longitudinal axis of the adaptor 3.

As shown in FIG. 2, the presence of the through-seat 40 defines, in the convex central portion 311 of the upper face 31 of the adaptor 3, first and second transverse convex portions, indicated using reference signs 311a, 311b respectively, each attached to either the first lateral flank 30a or the second lateral flank 30b. The through-seat 40 is therefore between the first transverse convex portion 311a and the second transverse convex portion 311b. According to the first embodiment shown in FIGS. 2 and 3, the longitudinal dimension of the through-seat 40 is equal to or substantially equal to the longitudinal dimension of the convex central portion 311 of the upper face 31 of the adaptor 3, measured along the longitudinal axis X of the adaptor.

According to an example embodiment of the invention, a recess 40 is formed in the convex portion 311 of the upper face 31 of the adaptor 3. The recess 40 has, in projection on a plane substantially parallel to the substantially flat first and second portions 310a, 310b of the upper face 31, a rectangular or substantially rectangular section, the large side of which is parallel to the longitudinal axis X of the adaptor 3 and the small side of which is parallel to the transverse axis Y.

According to an example embodiment, the adaptor 3 also has a first end flank 32a and a second end flank 32b that extend substantially perpendicular both to the substantially flat first and second portions 310a, 310b of the upper face 31 and two the first and second lateral flanks 30a, 30b. Each of the first and second end flanks 32a and 32b is attached both to the upper face of the adaptor 3 and to each of the lateral flanks 30a and 30b of same, such that the height H measured between each flat portion 310a, 310b of the upper face 31 at one end and each lower edge of the lateral flanks at the other end is constant. In other words, the first and second lateral flanks 30a and 30b on one hand and the first and second end flanks 32a and 32b on the other hand all have the same height H, measured vertically from the flat portion 310a, 310b of the upper face to which same are attached. The first and second lateral flanks 30a and 30b, the upper face 31 and the first and second end flanks 32a and 32b of the adaptor 3 thus together for internal cavity 33 designed to receive a portion of the connector 2, as described below.

According to the invention, at least one of the lateral flanks 30a, 30b of the adaptor 3 has a shoulder on the side of said lateral flank opposite the side by which same is attached to the substantially flat portions 310a, 310b of the upper face 31, said shoulder extending away from the volume of the internal cavity 33, i.e. towards the outside of the adaptor 3. According to the preferred embodiment of the invention shown in the figures, each of the first and second lateral flanks is provided with such a shoulder, indicated using reference sign 34a and 34b respectively. Each of these shoulders creates a gap, respectively 340a, on the corresponding first or second flank.

At least one of the end flanks 32a, 32b, and in particular each of the end flanks, has in particular a notch having a substantially rectangular overall shape and extending towards the upper face 31 on the side of same opposite the edge, respectively 320a, 320b, by which same is attached to the upper face of the adaptor 3. The purpose of this notch is specified below. Each notch 35a, 35b thus defines, on each of the first and second end flanks 32a, 32b, an inverted U-shape, the base of which is formed by the edge 320a, 320b shared with the upper face 31 and the corresponding end flank, and in which the lower faces of the tops of the branches form, along with the lower face of the shoulders 34a, 34b provided at the base of the first and second lateral flanks 30a, 30b, a bearing surface 340 for the adaptor 3. The shoulders 34a, 34b formed at the base of the first and second lateral flanks 30a, 30b are flush with the outer surface of each end flank 32a, 32b of the adaptor 3.

FIG. 3 is a bottom view of the adaptor 3 according to the first embodiment also shown in FIG. 2, showing in greater detail the internal layout of the cavity 33 delimited by the first and second lateral flanks, the upper face and the first and second end flanks of the adaptor 3. As shown in this figure, first and second ribs 36a, 36b are arranged parallel to the first and second lateral flanks 30a, 30b inside the cavity 33. Each of these ribs is thin, provides mechanical reinforcement for the adaptor 3 and extends along the entire length of the cavity 33 formed in the adaptor 3 between the inner edges of each of the notches 35a, 35b formed respectively in the first and second end flanks 32a, 32b. Advantageously, the dimensions of the adaptor 3 are defined such that the transverse dimension of the through-seat 40 is substantially equal to the distance separating the reinforcing ribs 36a, 36b inside the cavity 33 of the adaptor 3.

As shown in FIGS. 2 and 3, each of the first and second lateral flanks 30a and 30b is perforated, in the middle portion of same, along the longitudinal axis X, by a rotary bearing, indicated using reference sign 37a and 37b, designed to receive the shaft of the drive arm. The axis of the rotary bearing is transverse to the longitudinal axis X and passes through the lateral flanks of the adaptor 3. According to an example embodiment, this rotary bearing takes the form of transverse through-orifices of circular section that are coaxial and of the same diameter, the centres of same being aligned along the axis of rotation Y defined above.

According to the first embodiment shown in FIGS. 2 and 3, each of these transverse through-orifices, respectively 37a on the first lateral flank 30a and 37b on the second lateral flank 30b, is arranged in the middle portion along the longitudinal axis X of the corresponding lateral flank. The centres of the transverse through-orifices are positioned substantially in the middle of the adaptor 3, in the longitudinal direction of same. In the vertical direction, perpendicular both to the longitudinal axis X and the axis of rotation Y, the transverse through-orifices 37a, 37b are perforated substantially in the upper portion of the lateral flanks of the adaptor 3.

More specifically, according to this first embodiment of the invention, each of the first and second lateral flanks 30a, 30b of the adaptor 3 has, in the middle portion of same along the longitudinal axis X, a central portion, respectively 38a, 38b, that projects outside from the substantially flat outer surfaces of said lateral flanks, and that are attached at the upper portion of same to the convex central portion 311 of the upper face 31 of the adaptor 3.

According to the first embodiment of the invention shown in particular in FIGS. 2 and 3 and as described above, the convex central portion 311 of the upper face 31, which is shaped like a portion of a cylindrical surface, is centred on the axis of rotation Y. Consequently, the convex region 311 of the central portion of the upper face 31 of the adaptor 3 and the transverse through-orifices 37a, 37b formed on the first and second lateral flanks of said adaptor are coaxial along the axis of rotation Y. According to this embodiment of the invention, the projecting profile of each of the central portions 38a, 38b of the first and second lateral flanks 30a, 30b of the adaptor 3 is arranged such that the lower portion of the outer surface of each of these portions is flush with the external face of the corresponding shoulder 34a, 34b. The transverse through-orifices 37a and 37b open out onto the projecting central portions 38a, 38b of the first and second lateral flanks 30a, 30b of the adaptor 3.

According to the invention, the rotary bearing may include two circular-section rotary bearings 37a and 37b that are coaxial and for example of the same diameter. The centres of same are positioned substantially in the middle of the adaptor 3, in the longitudinal direction X of same, and are aligned along the transverse axis defined above. In the vertical direction, perpendicular both to the longitudinal axis X and the transverse axis Y, the rotary bearings 37a, 37b are perforated substantially in the upper portion of the lateral flanks of the adaptor 3.

More specifically, each of the first and second lateral flanks 30a, 30b of the adaptor 3 has, in the middle portion or same along the longitudinal axis X, a central portion, respectively 38a, 38b, that projects outside from the substantially flat outer surfaces of said lateral flanks, and that is attached at the upper portion of same to the convex central portion 311 of the upper face 31 of the adaptor 3. According to an embodiment of the invention shown in the figures and as described above, the convex central portion 311 of the upper face 31, which is shaped like a portion of a cylindrical surface, is centred on the transverse axis Y. Consequently, the convex region of the central portion 311 of the upper face 31 of the adaptor 3 and the rotary bearings 37a, 37b formed on the first and second lateral flanks of said adaptor are coaxial along the transverse axis Y.

The projecting profile of each of the central portions 38a, 38b of the first and second lateral flanks 30a, 30b of the adaptor 3 is arranged such that the lower portion of the outer surface of each of these portions is flush with the external face of the corresponding shoulder 34a, 34b. The rotary bearings 37a and 37b open out onto the projecting central portions 38a, 38b of the first and second lateral flanks 30a, 30b of the adaptor 3.

According to an example rotation of the rotary bearing 37a, 37b, a first cylindrical portion 39a and a second cylindrical portion 39b that are perforated by coaxial holes extend inside the cavity 33 between the inner wall of the corresponding lateral flank and the corresponding reinforcing rib 36a, 36b. These are therefore arranged symmetrically about a longitudinal mid-plane of the adaptor 3 that is perpendicular to the substantially flat portions 310a, 310b of the upper face 31 of the adaptor 3. These cylindrical portions are arranaed to face one another and extend substantially towards one another within the internal cavity 33. Each of these first and second cylindrical portions opens out, at one end, onto the inner wall of the corresponding lateral flank and opens out, at the other end, near to the corresponding reinforcing rib, passing through this latter. The cylindrical portions form a cylindrical trunnion, also having a transverse axis and indicated using reference signs 390a, 390b respectively, on the surface of the reinforcing ribs in question. These trunnions are seated in the connector 2, thereby enabling the adaptor to rotate in relation to the connector about the axis Y. These cylindrical trunnions are an example of the means for attaching the adaptor 3 to the connector 2.

The volume of the cavity 33 is therefore split into a central volume 33′ and four peripheral volumes 33″ arranged symmetrically firstly on each side of the central volume 33′ in the transverse direction and secondly on each side of the axis Y. The central volume 33′ is delimited by the inner walls of the reinforcing ribs 36a, 36b, the inner walls of the end flanks near to the notches 35a, 35b, and the transverse middle portion of the inner wall of the upper face 31 of the adaptor 3. Each of the peripheral internal volumes 33″ is defined by the inner wall of either the first lateral flank 30a or the second lateral flank 30b, the corresponding reinforcing rib 36a, 36b, the inner wall of one of the end flanks on one side of the corresponding notch 35a, 35b, the inner wall of the upper face 31 of the adaptor 3, and the outer wall of either the first cylindrical portion 39a or the second cylindrical portion 39b.

Each rotary bearing 37a, 37b thus extends through the corresponding Y-axis cylindrical portion 39a, 39b, the inner surface of which is cylindrical. More specifically and as shown in FIGS. 2 and 3, the inner cylindrical surface of each of the first and second cylindrical portions 39a, 39b, has a diameter less than the diameter of a counterbore, respectively 370a, 370b, the bottom of which is positioned transversely between the inner wall of the corresponding flank and the corresponding reinforcing rib, as shown in FIG. 3.

FIG. 4 shows a second embodiment of an adaptor 3 according to the invention. The main differences between this second embodiment and the first embodiment are as follows.

According to the second embodiment of the invention, shown in FIG. 4, the upper face 31′ of the adaptor 3 is formed by adjacent first and second convex portions 312 and 313. The convex first portion 312 is shaped like a portion of the envelope of a cylinder centred on the axis of rotation Y perpendicular to the longitudinal axis X, i.e. parallel to the direction of the axis (Oy) of the orthonormal frame defined above. The convex second portion 313 is shaped like a portion of the envelope of a cylinder centred on a transverse axis also parallel to the direction of the axis (Oy) of the orthonormal frame defined above. The first and second convex portions 312 and 313 are therefore parallel to one another in this case. More specifically, the first and second convex portions 312 and 313 are arranged substantially beside one another in the direction of one of the shared generator lines of same. According to the variant embodiment shown in FIG. 4, the external diameter of the cylindrical envelope portion that forms the second convex portion 313 of the upper face 31′ of the adaptor 3 is substantially less than the external diameter of the cylindrical envelope portion that forms the first convex portion 312 of said same upper face. With reference to the upper and lower directions defined above, the highest generator line of the second convex portion 313 is therefore beneath the highest generator line of the first convex portion 312 of the upper face 31′ of the adaptor 3. According to other variant embodiments not shown, the external diameters of the two cylindrical envelope portions that form the first and second convex portions 312, 313 respectively of the upper face 31′ of the adaptor 3 may be identical.

Furthermore, according to the second embodiment of the invention, the first and second end flanks, respectively 32a and 32b, extend advantageously as a lower vertical prolongation of the cylindrical envelopes that form respectively the first and second convex portions 312, 313 of the upper face 31′ of the adaptor 3. In this case, the edges 320a, 320b take the form of fillets that join each end flank 32a, 32b to the respective convex portion 312, 313 of the related upper face 31′.

Furthermore, in this embodiment of the invention, the through-seat indicated in this case using reference sign 40′ is arranged from one of the end flanks 32a of the adaptor 3 and extends inside the first and second convex portions 312 and 313. More specifically, the through-seat 40′ is in this case arranged from the first end flank 32a, thereby forming an opening. In other words, the through-seat 40′ in this case opens out in the first end flank 32a. According to the second embodiment of the invention, the through-seat 40′, in projection on a plane substantially parallel to the plane (Oxy) of the orthonormal frame defined above, is thereby delimited by three contiguous edges. The through-seat 40′ has a rectangular or substantially rectangular section in which the large side is parallel to the longitudinal axis X of the adaptor 3, one of the small sides is parallel to the axis of rotation Y, and the other small side opens onto the first end flank 32a.

As shown in FIG. 4, the presence of the through-seat 40′ thereby defines, in each of the first and second convex portions 312 and 313 of the upper face 31′ of the adaptor 3, two transverse convex zones, respectively 312a and 312b for the first convex portion 312, and 313a, 313b for the second convex portion 313, each attached to either the first lateral flank 30a or the second lateral flank 30b and arranged symmetrically about the axis of rotation Y on each side of the through-seat 40′.

According to this second embodiment, the through-seat 40′ extends along the longitudinal axis X along the entire length of the first convex portion 312 and a portion of the second convex portion 313. The presence of the through-seat 40′ thereby defines, within the adaptor 3, first and second secondary lateral flanks, respectively 30a′ and 30b, each formed by a vertical longitudinal wall bordering the through-seat 40′. The through-seat 40′ is also delimited by a transverse wall 32c arranged parallel to the second end flank 32b.

According to the second embodiment of the invention shown in FIG. 4, at least one longitudinal slot may be arranged on at least one of the transverse portions 313a, 313b of the second convex portion 313 of the upper face 31′ of the adaptor 3. According to a variant of this embodiment, two longitudinal slots 41′ are formed on the second convex portion 313 of the upper face 31′ of the adaptor 3, arranged symmetrically about a longitudinal mid-plane parallel to the first and second lateral flanks 30a, 30b of the adaptor 3 or, in other words, arranged symmetrically about the through-seat 40′. Each longitudinal slot 41 is perforated through the entire thickness of the first and second convex portions 313a, 313b of the upper face 31′, making same a through-slot. As in the first embodiment, this longitudinal slot receives the pin of the drive arm and thus locks the connection device according to the invention.

Also according to this second embodiment shown in FIG. 4, the first and second transverse through-orifices, respectively 37a′, 37b′, are in this case formed in the first and second lateral flanks 30a, 30b such that the centres of same are lined with the axis of rotation Y of the cylindrical envelope portion that forms the first convex portion 312 of the upper face 31′ of the adaptor 3. The first and second lateral orifices are coaxial with one another and also optionally coaxial with the first convex portion 312. These first and second transverse through-orifices 37a′, 37b′ may form the rotary bearing of the connection device according to the invention to provide a pivot about the axis of rotation Y between the wiper blade and the related drive arm.

Certain other characteristic elements of the adaptor 3 according to the invention, as illustrated in FIGS. 2 and 3 of a first embodiment and described in greater detail above, also fall within the scope of the second embodiment, as shown schematically in FIG. 4. This is in particular the case for the shoulders formed at the base of the lateral flanks 30a, 30b.

The functions and roles of the different elements that make up the adaptor 3 in the first or second embodiments of same are set out more dearly in the description below of the assembly of same with a connector 2 according to the invention, as illustrated in FIG. 5 and FIG. 7, and in the description of the assembly of the connection device B thus carried out with different types of end parts for windscreen wiper drive arms.

The connector 2 of the device according to the invention, shown schematically and in perspective in FIG. 5, is designed to be rigidly connected to the wiper blade A, for example by crimping. The connector provides a full or isostatic mechanical connection with the wiper blade A, i.e. once the connector is mounted on the wiper blade, there is no degree of freedom in relation to this latter. Where necessary, the connector 2 can convey and/or distribute the washer fluid for the surface to be wiped.

The connector 2 includes a base 20 that extends longitudinally along the axis X of the wiper blade and transversely along an axis perpendicular to this longitudinal axis and vertically, i.e. parallel to the axis (Oy) of the orthonormal frame defined above. The base 20 includes a zone for the rigid attachment of the connector 2 to the blade A. In the embodiment shown in FIG. 5, this rigid attachment zone takes the form of first and second longitudinal grooves 21a formed in the lower portion of the base 20 and arranged symmetrically about a vertical longitudinal mid-plane, the shape of each groove forming, around the edge of the base, a hook 22a that can be engaged with the wiper blade A.

The base 20 is surmounted by a substantially vertical flank 23 extending from the transverse middle portion of the base 20. According to one embodiment, the connector 2 is produced by injecting a polymer into an appropriate mould. As a result, the vertical flank is advantageously integrally formed with the base 20. The transverse dimension of the vertical flank 23 is less than the transverse dimension of the base. According to the embodiment of the invention shown in FIG. 4, the vertical flank 23 has a plurality of openings 230 and ribs 231 intended both to reduce the weight of same and to mechanically reinforce same.

The connector 2 has a transverse hole 24 through which an axis of rotation between the wiper blade and the drive arm passes. In the upper portion of same, the vertical flank is perforated by this transverse hole 24, which may for example be a through hole of circular section, the axis of which is the same as the aforementioned axis of rotation Y when the connector 2 has been assembled on the wiper blade A. The upper face 25 of the vertical flank 23 has a longitudinal convex middle portion 250 with a cylindrical profile that is for example coaxial with the transverse hole 24. The convex longitudinal middle portion 250 of the connector 2 thus extends in the vertical and upper directions defined above the rest of the upper face 25 of the connector 2. The transverse hole 24 receives the first cylindrical portion 39a and the second cylindrical portion 39b of the adaptor 3.

According to different embodiments, the connector 2 may also have, extending from the base 20 of same and as illustrated schematically in FIG. 7, a first vertical cover 27a and a second vertical cover 27b arranged on each side of the vertical flank 23 and intended to cover an air deflector of the wiper blade A. According to the variant embodiment illustrated in FIG. 7, the first and second vertical covers 27a, 27b are arranged symmetrically on each side of the vertical flank 23 about the axis of rotation Y.

FIG. 6 shows a connection device according to the invention including a connector 2 as described in relation to FIG. 5 and an adaptor 3 according to the first embodiment described above and illustrated by FIGS. 2 and 3, assembled on a wiper blade A. The adaptor 3 is in this case assembled on the connector 2 using a vertical translational movement in a direction substantially parallel to the first and second lateral flanks 30a, 30b of the adaptor 3, and substantially perpendicular to the flat portions 310a, 310b of the upper face 31 of said adaptor 3 in the direction shown by the arrow F in FIG. 6. Specifically, the user places the adaptor 3 above the connector 2 then exerts a pressure oriented in the direction shown by the arrow F in FIG. 6 on the upper face 31 of the adaptor 3. The vertical flank 23 of the connector 2 is then engaged in the internal central volume 33′ of the adaptor 3, the transverse dimension H1 of same is advantageously equal to or very slightly greater than the transverse dimension h1 of the vertical flank 23 (FIG. 5) such that said vertical flank can be inserted into the internal central volume 33′ without excessive force. Advantageously, the dimensions of the adaptor 3 are determined such that the internal longitudinal dimension of the central volume 33′ of same is very slightly greater than the external longitudinal dimension of the connector 2.

The connector 2 is then linked to the adaptor 3 by elastic click-fitting of the cylindrical trunnions 390a and 390b formed by the first and second cylindrical portions perforated by the holes 39a, 39b in the transverse hole 24 of the connector 2, respectively on each side of the vertical flank 23. According to one embodiment of the invention, in order to facilitate this click-fitting, a first gap and a second gap, respectively 26a, are formed on each side of the upper central portion of the vertical flank 23 of the connector 2 above the transverse hole 24 and near to the axis of same. Advantageously, the dimensions and shape of each of the first and second gaps 26a are defined jointly with the thickness of the cylindrical trunnions, respectively 390a, 390b, to enable each of said cylindrical trunnions to engage in the transverse hole 24 of the connector 2 and to enable the adaptor 3 to be locked onto the connector 2 once said engagement has been made.

According to the embodiment of the invention shown in the figures, the internal diameter of the transverse hole 24 of the connector 2 is equal to the internal diameter of each of the cylindrical portions 39a, 39b formed in the adaptor 3. A transverse cylindrical passage centred on the axis Y is therefore formed inside the connection device according to the invention by the assembled connector 2 and adaptor 3.

As shown in FIG. 6, once the connector 2 has been assembled with the adaptor 3, the recess 40 formed in the upper face 31 of the adaptor 3 then forms an opening through which the convex central portion 250 of the vertical flank of the connector 2 emerges, in a direction perpendicular to the direction of the axis of rotation Y, through the upper face 31 of the adaptor 3. As mentioned above and shown in FIG. 2, the presence of the recess 40 defines, in the convex central portion 311 of the upper face 31 of the adaptor 3, first and second transverse convex portions, respectively 311a, 311b, each being attached to either the first lateral flank 30a or the second lateral flank 30b, one of which is attached to the upper portion of the central portion 38a of the first lateral flank 30a and the other of which is attached to the upper portion of the central portion 38b of the second lateral flank 30b.

According to the embodiment of the invention shown in the figures, the dimensions of the connector 2 and of the adaptor 3 are determined such that, once the two elements had been assembled, the convex central surfaces of the upper faces of the connector and of the adaptor, respectively the convex surfaces 250, 311a and 311b, are aligned and substantially flush with one another. In other words, once the connector 2 and the adaptor 3 have been assembled, these surfaces together substantially form a single cylindrical convex surface centred on the axis Y. Such an arrangement helps to limit the aerodynamic noise commonly generated by sharp edges.

The function of the notches 35a and 35b formed in the end flanks of the adaptor 3 is also clearly shown in FIG. 6: each of these notches fits together with the upper portion of the wiper blade A. These notches therefore form a gap into which the air deflector of the wiper blade extends.

The adaptor 3 thus forms a sort of cover for the connector 2 contained within same. The invention therefore provides a simple, compact connection device that is easy to assemble and disassemble and that is sealed in that potential ingress zones for dirt and particles into the device according to the invention are minimized or eliminated, both by the presence of the notches formed in the end flanks of the adaptor 3, which surround the upper portion of the wiper blade, and by the close cooperation of the upper portion of the connector 2 in the recess 40 formed in the upper face of the adaptor 3, in particular the convex portion 250 of the connector 2 with the central portion 311 of the adaptor 3.

Finally, the adaptor 3 has only two cavities 41, both formed through the same substantially flat portions 310a or 310b delimiting the adaptor 3. The other substantially flat portion is full, i.e. has no cavities.

FIG. 7 is a schematic illustration of two assembly options for the adaptor 3 according to the invention, in the second embodiment of same as illustrated in FIG. 4.

The assembly method involves sliding the adaptor 3 onto the connector 2 by seating the vertical flank 23 of the connector into the through-seat 40′ of the adaptor 3. The rotary bearing 37a, 37b is then aligned with the transverse hole 24 of the connector 2, then a shaft of the drive arm is slid into the rotary bearing and into the transverse hole.

According to this second embodiment, the adaptor 3 is asymmetrical when viewed in relation to a vertical transverse mid-plane, i.e. parallel to the plane (Oyz) of the orthonormal frame defined above. The transverse through-orifices 37a′, 37b′ of the adaptor 3 are in this case positioned longitudinally off centre on the adaptor 3 by being placed near to the convex first portion 312 of said adaptor 3. Consequently, two assembly directions of the adaptor 3 on the connector 2 are possible, as shown in FIG. 7. According to these different assembly directions, the convex second portion 313 of the adaptor 3 is on one side or the other side of the vertical flank 23 of the connector 2 along the longitudinal axis X of the wiper blade A to which this connector 2 is rigidly attached.

If the adaptor 3 is made according to the second embodiment, more specifically illustrated in FIG. 4, the presence of a free space on the longitudinal side of the vertical flank 23 of the connector 2 opposite the side receiving the convex second portion 313 of the upper face 31′ of said adaptor 3 enables the complementary positioning of a cap intended, for example, to provide an aesthetic finish for the connection device in line with the general appearance of the vehicle. In this case, the absence of a vertical transverse plane of symmetry in the adaptor 3 enables this type of cap to be used regardless of the assembly direction of the device according to the invention, and in particular regardless of the driving side of the vehicle fitted with such a device.

FIGS. 8 to 10 show different assembly examples of a connection device according to the invention, as described above with different types of windscreen wiper drive arm known as a “side lock” type.

FIGS. 8 to 10 show different assembly examples of a connection device according to the invention, as described above with different types of windscreen wiper drive arm known as a “side lock” type. The adaptor shown in the assembly in these figures is the adaptor described in relation to the first embodiment illustrated by FIGS. 2 and 3, but naturally the assembly, as well as the features and advantages of same, is similar for a connection device including an adaptor and a connector as described by the second embodiment shown in FIG. 7.

FIGS. 8 and 9 show more specifically the assembly of a connection device B according to the invention, as described above with the end part 5 of a drive arm C in a connection of the type known as “narrow side lock”. FIG. 6 shows assembly of the elements of such a connection, and FIG. 7 shows the wiper blade A, the connection device according to the invention B, and the drive arm C assembled according to such a connection.

With reference to FIG. 8, the end part 5 of the drive arm C in a narrow side-lock connection is formed schematically by a base 50 that extends substantially longitudinally in the general direction of the drive arm C and that is in general fitted into the free end of a rod forming the drive arm. A substantially cylindrical shaft 51 and an attachment pin 52 extend from the base 50 in a direction perpendicular to the longitudinal direction of the drive arm C. More specifically, the direction of the axis of the shaft 51 is parallel to the direction of the axis Y described above.

The attachment pin 52 is in the form of a plate the overall shape of which is substantially an “L” shape and in which the main branch 520 extends from the base 50 substantially parallel to the direction of the axis of the cylindrical shaft 51, and in which a shorter end branch 521 extends substantially perpendicular to the main branch 520 such that, when the drive arm C fitted with the end part 5 of same is assembled with the connection device B according to the invention installed on a wiper blade A, this end branch extends towards the rubber 10 of the wiper blade A, i.e. towards the windscreen.

During assembly of the wiper blade A on such a drive arm via a connection device B according to the invention, the shaft 51 is engaged in a transverse cylindrical passage, centred on the axis Y, formed by the transverse hole 24 of the connector 2, by the transverse rotary bearings, respectively 37a, 37b, and by the first and second cylindrical portions 39a, 39b perforated in the holds of the adaptor 3.

According to the embodiment of the invention shown in FIG. 6, the shaft 51 has a base 510 of larger diameter in the connection zone of same to the base 50. Advantageously, the diameter of the counterbores 370a, 370b, respectively arranged about each of the transverse rotary bearings 37a, 37b perforated in each of the first and second lateral flanks 30a, 30b of the adaptor 3, is selected to seat the base 510 of the shaft 51 such that this latter bears against the back of the counterbore located on the side of the connection device B engaging the shaft 51. The shaft 51 is therefore engaged and locked circumferentially in the connection device B according to the invention.

The axis Y, materialized by the shaft 51 engaged in the transverse cylindrical passage of the connection device according to the invention B, is therefore the axis of rotation between the wiper blade A and the related drive arm C.

Advantageously, the dimensions of the adaptor 3 are such that, when the shaft 51 is engaged in the transverse cylindrical passage of the connection device B according to the invention, the end branch 521 of the pin 52 is facing one of the cavities 41 formed in the upper face 31 of the adaptor 3. The assembly sequence of the wiper blade A on the drive arm C is therefore as follows:
Engage the shaft 51 in the transverse cylindrical passage of the connection device in the direction shown by the arrow F1, parallel to the axis Y, until the base 510 of the shaft 51 butts against either one of the counterbores 370a, 370b in of the adaptor 3,
Rotate the wiper blade A about the axis of rotation Y in the direction shown by the arrow F2 in FIG. 6 to engage the end portion 521 of the pin 52 in the cavity 41 facing same.

Once assembly has been completed and as shown in FIG. 9, the main branch 520 of the pin 52 is substantially bearing against either one of the substantially flat portions 310a, 310b of the adaptor 3, and any movement of the end part 5 in the direction of the axis of rotation Y is prevented by engagement of the end branch 521 of the pin 52 in a cavity 41 of the adaptor 3. Advantageously, to reinforce the link between the drive arm and the connection device according to the invention a stud 522 may be formed on the free end of the end branch 521 of the pin 52. When the end branch 521 of the pin 52 is inserted into one of the cavities 41 of the adaptor 3, the stud 522 can then engage beneath the lower wall of the upper face 31 of the adaptor 3, thereby forming means for preventing the rotation of the wiper blade in relation to the drive arm.

To disassemble the drive arm and the wiper blade fitted with the connection device according to the invention, the steps of the assembly sequence described above need simply be carried out in reverse order.

The invention therefore enables the assembly of a drive arm fitted with a narrow side lock end part on a wiper blade using a compact connection device that is easy to use. Thus, in the example shown in FIGS. 8 and 9, the end branch of the pin of the drive arm is engaged in the cavity 41 furthest away from the lateral flank of the adaptor 3 against which the drive arm is positioned. Naturally, such a layout is not exclusive and it is entirely possible for other geometric variants of the end part of the drive arm to be used so that the end branch of the pin of the drive arm is for example engaged in the cavity 41 nearest to the lateral flank of the adaptor 3 against which the drive arm is positioned.

FIG. 10 shows more specifically the assembly of a connection device B with an end part 5′ of a drive arm C′ of the type known as “standard side lock”. According to the invention, the connection device is identical for an end part 5 of a standard side-lock drive arm C and for an end part 5 of a narrow side-lock drive arm C.

As with a narrow side-lock connection, the end part 5′ of a drive arm C′ in a standard side-lock connection is formed by a base 50′ that extends substantially longitudinally in the general direction of the drive arm C′ and that is in general fitted into the free end of a rod of the drive arm. A substantially cylindrical shaft 51′ and an attachment pin 52′ extend from the base 50′ in a direction perpendicular to the longitudinal direction of the drive arm C′. The shaft 51′ is similar to the shaft 51 described above for a narrow side-lock connection and the description of this shaft and of the cooperation of same with the counterbores 370a and 370b is incorporated here.

The differences with the narrow side-lock connection relate to the geometry and the dimensions of the pin 52′. As with a narrow side-lock connection, the pin 52′ has an overall “L” shape. The main branch 520′, and potentially the end branch 521′ of the pin 52′, are in this case longer than in a narrow side-lock connection, Furthermore, the end of the end branch 521′ in this case has a slight curvature 523 in the transverse direction. According to the embodiment shown in FIG. 8, the curvature 523 is oriented outwards, i.e. away from the drive arm C.

During assembly of such a drive arm with a connection device B according to the invention installed on a wiper blade A, the shaft 51′ is engaged in the middle transverse cylindrical passage of the connection device B in the same manner as for a narrow side-lock connection described above. As with a narrow side-lot connection, the axis Y, materialized by the shaft 51′ engaged in the middle transverse cylindrical passage of the connection device B, is then the axis of rotation between the wiper blade A and the related drive arm C′.

Advantageously, the dimensions of the adaptor 3 are such that, as shown in FIG. 8, when the shaft 51′ is engaged in the middle transverse cylindrical passage of the connection device, the main branch 520′ of the pin 52′ extends along the entire transverse dimension of the connection device B. The end branch 521′ of the pin 52′ is then facing the outer wall of the lateral flank 30a or 30b of the adaptor 3 furthest away from the flank against which the drive arm C′ is positioned. Thus, the pin 52′ maybe engaged above the adaptor 3 with the end branch 521′ seated in one of the gaps 340a, 340b formed on the lateral flank of the adaptor 3. According to the invention, the dimensions of the adaptor 3 are defined such that, once the pin 52′ has been fitted onto the upper portion of the adaptor, the slightly curved end 523 of the end branch 521° bears against one of the shoulders 34a, 34b formed at the base of the first and/or second lateral flanks of the adaptor 3.

The assembly sequence of the drive arm C′ on the assembly formed by the wiper blade A and the connection device B according to the invention is then as follows:
Engage the shaft 51′ in the middle transverse cylindrical passage of the connection device in the direction shown by the arrow F1′ in FIG. 10, parallel to the axis Y, until the base of the shaft 51′ butts against either one of the counterbores 370a, 370b of the adaptor 3, the shaft 51′ thereby being radially locked in the connection device B according to the invention,
Pivot the wiper blade A in relation to the drive arm C′ about the axis Y in the direction shown by the arrow F2′ in FIG. 10 to fit the pin 52′ about the upper portion of the adaptor 3 until the end branch 521′ of the pin 52′ is seated in one of the gaps 340a, 340b formed on the first and/or the second lateral flank 30a, 30b opposite the lateral flank against which the drive arm C′ is placed.

To disassemble the drive arm and the wiper blade fitted with the connection device according to the invention, the steps of the assembly sequence described above need simply be carried out in reverse order.

The invention thus enables the assembly of a wide variety of windscreen wiper drive arms on a wiper blade using simple sequences and a single connection device. The connection device proposed by the invention is also easy to assemble and easy to mass produce on account of the layout of the connector and the adaptor comprising same. The connection device according to the invention also provides a good seal, inasmuch as the potential points of ingress for water and dirt into same are minimized or eliminated. The invention therefore in particular enables standard site-lock and narrow side-lock arms to be assembled using simple sequences and a single type of connection device.

The connection device proposed by the invention is also easy to assemble and easy to mass produce on account of the layout of the connector and the adaptor comprising same.

However, the invention is not limited to the means and arrangements described and illustrated, but also applies to any equivalent means or arrangements and any combination of such equivalent means. Furthermore, any variant set out in relation to the first embodiment of the adaptor of such a connection device can naturally also apply if such an adaptor is of the type described by the second embodiment in this document.

1. A connection device for mechanically linking a wiper blade to a windscreen wiper drive arm of a motor vehicle, said connection device comprising:
a connector configured to be rigidly attached to the wiper blade; and
an adaptor for connecting the connector to an end part of the drive arm,
wherein the connector includes at least one hole of circular section through which the axis of rotation between the wiper blade and the drive arm passes, the hole in the connector being delimited by at least one flank of the connector, and
the adaptor having at least one through-seat into which at least a portion of the flank extends.

2. The device according to claim 1, wherein the at least one hole has a circular section.

3. The device according to claim 1, wherein the through-seat is formed in an upper face delimiting the adaptor.

4. The device according to claim 3, wherein the through-seat is delimited by a closed edge.

5. The device according to claim 3, wherein the through-seat is centred on the adaptor, along a longitudinal axis of said adaptor, and borders two substantially flat portions of the upper face and two substantially convex portions delimiting the upper face of the adaptor.

6. The device according to claim 5, wherein the through-seat has, in projection on a plane parallel to the substantially flat first and second portions of the upper face, a substantially rectangular section in which the large side is parallel to the longitudinal axis of the adaptor and the small side is substantially parallel to the axis of rotation.

7. The device according to claim 3, wherein the through-seat is formed in a first convex portion and a second convex portion that delimit the upper face of the adaptor.

8. The device according to claim 3, wherein the adaptor is delimited by a first lateral flank and a second lateral flank, at least one of said lateral flanks having a shoulder formed on an edge opposite the edge via which the lateral flank is attached to the upper face of the adaptor.

9. The device according to claim 8, wherein each of the first and second lateral flanks of the adaptor has a shoulder.

10. The device according to claim 3, wherein at least one longitudinal slot is formed in the upper face of the adaptor.

11. The device according to claim 10, wherein four through-slots are formed in the upper face of the adaptor, distributed symmetrically both about a longitudinal mid-plane perpendicular to the substantially flat portions of the upper face and about a transverse mid-plane perpendicular to the first and second lateral flanks of the adaptor.

12. The device according to claim 1, wherein the adaptor is delimited by at least a first lateral flank and by a second lateral flank, a rotary bearing being provided in said first and second lateral flanks to receive a shaft of the drive arm.

13. The device according to claim 12, wherein the rotary bearing is formed by at least one orifice of circular section passing through the first and second lateral flanks, and the through-orifices are coaxial and of the same diameter, the centres of same being aligned on the axis of rotation.

14. The device according to claim 13, wherein a first cylindrical trunnion and a second cylindrical trunnion extend, coaxial with the through-orifices, inside a cavity formed by the first and second lateral flanks, the first and second end flanks, and the upper face of the adaptor.

15. The device according to claim 14, wherein the first and second cylindrical trunnions have the same internal diameter as the first and second through-orifices, and extend substantially towards one another within the volume of said cavity.

16. The device according to claim 13, wherein the profile of the upper face of the adaptor, near to each of the through-orifices, is identical to the profile of an upper wall delimiting the flank of the connector near to the hole.

17. A connection device for mechanically linking a wiper blade to a vehicle windscreen wiper drive arm comprising a shaft and a pin, the connection device comprising:
a connector designed to be rigidly attached to the wiper blade and having at least one transverse hole designed to receive the shaft;
an adaptor designed to connect the connector to the drive arm, including at least one rotary bearing designed to receive the shaft and means for attaching the adaptor to the connector, the adaptor having at least one cavity that is substantially perpendicular to a transverse axis passing through the rotary bearing and that is designed to receive the pin, in which the rotary bearing, the transverse hole and the attachment means are coaxial.

18. The device according to claim 17, wherein the cavity is delimited by a closed edge.

19. The device according to claim 18, wherein the closed edge of the cavity is formed in a portion of an upper face of the adaptor.

20. The device according to claim 17, wherein the adaptor is delimited by lateral faces, and wherein the adaptor comprises at least one gap formed in one of said lateral faces, the gap being designed to receive a pin of a drive arm.

21. The device according to claim 20, wherein the adaptor includes at least one gap on each of the lateral faces of same.

21. The device according to claim 17, wherein the rotary bearing has a first bearing and a second bearing that are coaxial, the first bearing being separated from the second bearing by a recess that opens onto the upper face of the adaptor.

23. The device according to claim 22, wherein at least one portion of the connector projects into the recess in the adaptor between the first bearing and the second rotary bearing.

24. The device according to claim 17, wherein the means for attaching the adaptor to the connector are cylindrical trunnions coming from the adaptor and seated in at least one matching hole formed in the connector.

25. The device according to claim 17, wherein the upper face of the adaptor, near to the rotary bearing, has a profile similar to the profile of an upper wall of the connector near to the central portion of this latter, in which the transverse hole is formed.

26. A wiper blade for a motor vehicle, comprising a connection device according to claim 17.

27. A wiper system for a vehicle, comprising:
at least one wiper blade according to claim 26 attached to a drive arm by a connection device;
a shaft carried by an end part of the drive arm being seated in the rotary bearing of the adaptor; and
a pin being seated in the cavity.

28. A wiper system for a motor vehicle, comprising:
one wiper blade according to claim 26 attached to a drive arm by a connection device;
a shaft carried by an end part of the drive arm being seated in the rotary bearing of the adaptor; and
a pin being seated in a gap formed in a lateral flank of the adaptor.
